(19) United States
(12) Patent Application Publication
(10) Pub. No.: US 2022/0118785 A1
(43) Pub. Date: Apr. 21, 2022

(54) SEED AUTHENTICATION AND/OR GERMINATION ENHANCEMENT WITH THE CREATION OF MICROSTRUCTURES

(71) Applicant: NATIONAL UNIVERSITY OF SINGAPORE, Singapore (SG)

(72) Inventors: Kenny Yong Keng ONG, Singapore (SG); Choon Kiat LIM, Singapore (SG); Kristav McDonald CHILDRESS, Singapore (SG)

(73) Assignee: NATIONAL UNIVERSITY OF SINGAPORE, Singapore (SG)

(21) Appl. No.: 17/423,543

(22) PCT Filed: Oct. 31, 2019
(86) PCT No.: PCT/SG2019/050534

§ 371 Date: Jul. 16, 2021

(30) Foreign Application Priority Data
Jan. 16, 2019 (SG) 10201900420X

(51) Int. Cl. B41M 3/14; G06T 1/00; G06V 10/10; B23K 26/362

(52) U.S. Cl. CPC B41M 3/14; B23K 26/362; G06V 10/19; G06T 1/0021

(57) ABSTRACT

A method and device for seed authentication, and a method and device for improving seed germination. The method for seed authentication comprises marking the testa of a seed with a watermark comprising an area in which the testa is at least partially removed by forming microstructures in the testa.

### FIELD OF INVENTION

The present invention relates broadly to seed authentication and/or germination enhancement via the creation of surface microstructures, in particular by the use of high-speed lasers.

### BACKGROUND

Any mention and/or discussion of prior art throughout the specification should not be considered, in any way, as an admission that this prior art is well known or forms part of common general knowledge in the field.

Counterfeit seeds are a huge problem in the seed industry. Legitimate seed companies spend considerable time, skill and money to breed, condition and market high performance seeds. Counterfeit seeds are often of lower quality and farmers do not experience the promised improvement in performance of genuine seeds. Thus, in addition to loss of sales for seed companies, this can also result in reputational losses for these companies as well as greatly reduced harvests for farmers relying on an expected seed quality. This creates distrust and inefficiencies in the seed market.

Currently, most authentications of agricultural seeds to protect against rampant counterfeiting are done either via seed packaging or by using various coatings or additives. Reliable authentication of seeds at a seed level is a demand that has not been met.

On the other hand, traditional priming methods for seeds to increase germination require wetting the seeds, which poses challenges such as the wetting process, can be difficult to control/reproduce.

US20050210744A1 describes a method for improving germination of hard seed by laser beam irradiation and germination improved seed. Specifically, a perforation method is used whereby holes are created in the testa (i.e. seed coat). The area of laser irradiation leading to perforation is from 0.2 to 20% of the seed testa surface area. The perforation is targeting the hilum or micropyle where the seed embryo emerges for the purpose of removing testa ‘material’. Additional priming methods, such as coating granulations, film coatings, a seed tape process and a seeding sheet process are described to facilitate the methods.

U.S. Pat. No. 10,002,277B1 describes a reader device for reading a marking comprising a Physical Unclonable Function (PUF) on objects. Specifically, the method of authentication (reading of information) in this patent is a covert method whereby specific device/s need to be used to read the markings. Light of a specific wavelength is used to read based on photon upconversion whereby a photon of shorter wavelength is produced. The laser or light used retrieves the necessary data based on the emission spectrum received from the PUF. The focus is on the digital signal response using an algorithm-based method (addition of hash value to the digitized function). Detection is via the optical interference of a speckle pattern and hence observing the emission spectrum of a dye. The microstructures formed are uncontrollable and randomized based on the content of the dyes, i.e. the PUF. The dye/content absorbs photons of a particular wavelength, and the emission spectrum differs with a high order of permutation. The method is based on the assumption that the dye does will not experience any changes due to humidity effects, chemical additives and/or heat. Seed authentication using dyes might be deemed unsafe for commercial seeds used for farming due to presence of ions and their penetration of the seed. The method is also difficult to use for seeds that are very small.

U.S. Pat. No. 8,033,450B2 describes expression codes for microparticle marks based on signature strings. It aims to apply microparticles to the object of interest with a carrier substrate (layer) with a subsequent process of etching out the layer with a chemical or via an evaporation process after the microparticle has set on the surface of the object. Such techniques might be deemed unsuitable for seed authentication.

CN 203194113 U describes a method to authenticate the seeds by coating with identifiable materials, or engraving and printing letters, numbers, patterns or combination of thereof with laser, onto the seed itself. The inventor described the use of HL-640E and GD-C02M30 laser models, which is significantly different from the ultrashort pulsed lasers, such as the femtosecond laser that is described in this invention disclosure.

US20130048728A1 describes utilizing micro- or nano-particulate taggants deposited onto the seeds to prevent counterfeiting. It relies on the verification of an “external” marker.

CN108705203A describes methods that use lasers to create security markings on metallic surface for anti-counterfeiting purposes. The described technology is only applicable on metallic surfaces with a film to absorb or reflect photons of a specific range of wavelength. Such techniques might be deemed unsuitable for seed authentication on the natural surfaces of individual seeds.

U.S. Pat. No. 8,975,597 B2 describes a method to authenticate seeds by marking the seed, the seed coating or the coated seed, with multi-colour chemical markers in UV, visible or near infrared wavelength. These multi-colour marked seeds can then be detected and authenticated with the use of specialized instruments. However, the chemicals are potentially subject to copying and co-option by counterfeiters. The technique does not create microstructures on the seeds.

“Drug-laden 3D biodegradable label using QR code for anti-counterfeiting of drugs”; Materials Science and Engineering C, Volume 63, 1 Jun. 2016, Pages 657-662, describes a non-fluorescence method to create a QR code on the surface of the drug by laser cutting on the PMMA mask. It is evident that laser cutting on an encoding mold is indispensable. Such techniques are unsuitable for seed authentication on the natural surfaces of individual seeds.

“Identifying Study on Hybrid Rice Seeds of Broken Glumes Based on Computer Vision Technology”; Journal of Anhui Agricultural Sciences; Volume 38; Issue: 23; 2010, describes image processing as the main tool to identify naturally occurring cracks on the surface of rice seeds. Such techniques might be deemed unsuitable for seed authentication on the natural surfaces of individual seeds

“RFID-Based Agro-Materials Anti-Counterfeiting Management System in Whole Logistics Chain”; Proceedings of the 2012 Second International Conference on Electric Technology and Civil Engineering; Pages 2443-2446; Published: May 2012 describes methods for tagging agro-materials with RFID, POS and barcode to track the agro-materials down the logistics chain. The methods described in this paper would only be possible to integrate onto the seed packaging, and would not be suitable for seed authentication on the natural surfaces of individual seeds.

“Research on Food Safety Traceability Technology Based on RFID Security Authentication and 2-Dimensional Code”: Innovative Mobile and Internet Services in Ubiquitous Computing, Pages: 517-526; June 2018, describes methods for tagging food product with RFID technology combined with anti-counterfeiting and Internet of Things (“IOT”) technology. The methods described in this paper would only be possible to integrate onto the seed packaging, and would be unsuitable for seed authentication on the natural surfaces of individual seeds.

In “Chemical and physical pre-treatments to improve in vitro seed germination of Humulus lupulus L., cv. Columbus”; Scienttia horticulturae, vol 235, pp 86-94, 17 May 2018 and “Differential water uptake kinetics in axes and cotyledons during seed germination of Vigna radiate under chilling temperature and cycloheximide treatment”; Braz. J. Plant Physiol., 20(4); 277-284, 2008, scarification of the seed coat by chemical or physical means is described. Chemically scarification include the use of sulfuric acid or gibberellic acid and physical scarification include rubbing against sandpaper or puncturing using a needle or sound stimulation. The creation of microstructures is used to increase water uptake and affects the uncovering of seed coat so that the seed more readily absorbs water and expands. The use of, difficult to control, chemical and other physical scarification methods for puncturing the seat coat would be unsuitable for seed authentication on the natural surfaces of individual seeds.

Embodiments of the present invention seek to address at least one of the above problems.

### SUMMARY

In accordance with a first aspect of the present invention, there is provided a method of seed authentication comprising marking the testa of a seed with a watermark comprising an area in which the testa is at least partially removed by forming microstructures in the testa.

In accordance with a second aspect of the present invention, there is provided a method for improving seed germination, the method comprising marking an area of the testa of a seed by forming microstructures in the area to enhance imbibition.

In accordance with a third aspect of the present invention, there is provided a device for marking the testa of a seed with a watermark comprising an area in which the testa is at least partially removed by forming microstructures in the testa, for seed authentication.

In accordance with a fourth aspect of the present invention, there is provided a device for marking an area of the testa of a seed by forming microstructures in the area to enhance imbibition, for improving seed germination.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1A shows a schematic of a watermark comprising microstructures to be laser marked onto the testa, according to an example embodiments.

FIG. 1B shows the corresponding actual laser mark image on a seed, respectively, according to an example embodiment.

FIG. 1C shows a schematic drawing illustrating a laser system for creating the microstructure-based watermark on the surfaces of the seeds according to an example embodiment.

FIG. 1D shows a schematic drawing illustrating a cross section of the seed template 102 used in the laser system of FIG. 1C.

FIG. 2A shows a portion of a normal seed surface.

FIG. 2Bs shows a portion of a seed surface with a watermark comprising microstructures formed on the seed surface, according to example embodiments.

FIG. 3 shows an image of a portion of a watermark comprising microstructures with a pattern created on Vigna radiata seed surface, according to an example embodiment.

FIG. 4A shows an image of a watermark comprising first and second layers of different respective microstructures, according to an example embodiment.

FIG. 4B shows an image of a watermark comprising first and second layers of different respective microstructures, according to an example embodiment.

FIG. 5A shows a surface morphology graph after a post-image process illustrating that consistent microstructures of a watermark can be observed, according to an example embodiment.

FIG. 5B shows surface morphology of a normal seed, for comparison.

FIG. 6 shows a surface morphology graph after a post-image process illustrating consistent first layer microstructures from 0-130 & 180-300 (distance) and second layer microstructures with specific patterns from 130-180, of a watermark according to example embodiments.

FIG. 7 shows an example of microstructures of a watermark on the seed coat of Vigna radiate, according to an example embodiment.

FIGS. 8A and B show the germination rating after 6 hours (placed in a medium that can readily retain water moisture, i.e. without soaking) in table form and in graph form, respectively, according to example embodiments.

FIGS. 9A and B show results germination rating after 8 hours (placed in a medium that can readily retain water moisture, i.e. without soaking) in table form and in graph form, respectively, according to example embodiments.

FIGS. 10A and B show weight gain compared to the dry weight after 20 hours in table form and in graph form, respectively, according to example embodiments.

FIGS. 11A and B show length after 20 hours (placed in a medium that can readily retain water moisture, without soaking) Length of hypocotyl (in mm) in table form and in graph form, respectively, according to example embodiments.

FIGS. 12A and B show results of germination rating after 8 hours of submerged seeds in table form and in graph form, respectively, according to example embodiments.

FIGS. 13A and B show lengths of hypocotyl (in mm) after 20 hours with soaking in table form and in graph form, respectively, according to example embodiments.

FIG. 14 shows a schematic drawing illustrating a cross-sectional view of a portion of a multi-layered microstructure with a V-shaped or tapered groove that is tilted at an angle, for a watermark according to an example embodiment.

FIG. 15 shows a schematic drawing illustrating creation of the multi-layered microstructure for the watermark of FIG. 14.

### DETAILED DESCRIPTION

Embodiments of the present invention provide methods and systems to verify the authenticity of any seed with hard seed coats (tough and impermeable testa). The methods and systems according to example embodiments can also improve the germination rates, percentage and uniformity, and may be used for that application, optionally as a substitute, or to supplement, current priming methods.

Embodiments of the present invention utilize the reliable and detailed marking of individual seeds for authentication at the seed-level. Lasers are used to create microstructures on the surface of each seed according to example embodiments. “Microstructures” is meant to include not just structures at micron scale but can range anywhere from centimeter to nanometer. The lasers used according to example embodiments include pulse widths of nanosecond, picosecond and femtosecond. Wavelengths in the ultraviolet, visible spectrum and infrared can be used for machining on the seed and the speed of the laser, that is dependent on the servo controller of the laser scanner, can range from 10 mm/s to 3000 mm/s. The microstructures created leave an easily verifiable mark, herein after also referred to as ‘watermark”, on the surface of the seed coating (i.e. testa), which can be verifiable by naked eye, whereas further verification comprises the analysis of the actual microstructures by e.g. image processing algorithms.

Advantageously, another layer of microstructures within the watermark are formed with a second pattern which is extremely difficult to replicate, particularly if the type of laser and parameters originally used to create them are not known to the counterfeiter. It is noted that the microstructures can stack on top of each other in multiple layers, i.e. not limited to just two layers, and can be in any sequence and is not limited by the example embodiments described herein. “Pattern” is meant to include the second and/or subsequent layers being made up of microstructures which include, but are not limited to, words, alphabets, symbols, shapes, image or any other geometry that can be produced by laser beams, and can be in 3D as well, eg pyramid, dome etc.

In example embodiment of the present invention, a change in laser parameters and patterns used for any batch of seeds greatly increases the challenge of replication by seed counterfeiters. The microstructures can also be read (e.g. using image processing) and verified, e.g. by the use of Artificial Intelligence, to analyse the presence and details of microstructures created by the lasers as well as any added overall patterns generated during the same process of forming the watermark, according to example embodiments. The unique microstructure-based watermark according to example embodiments can advantageously be changed or added to provide a unique microstructural “trademark” for a seed owner—comparable to branding individual animals on a farm—in addition to the general authentication of the pattern of the microstructures themselves that are created. It is noted that seed authentication provided for seed companies selling their seeds need not be done for every seed but only a small number of visibly marked seeds within each package. This can significantly reduce the cost and time it takes to provide seed-level authentication according to example embodiments. It is also noted that other methods such as nano-machining can be used in different embodiments to create similar microstructures. The microstructure-based watermark created on the seed surfaces can also be matched to unique codes on the packaging of the seeds to provide another layer of authentication. “Unique codes” is intended to include QR code, barcodes, scratch reveal codes, etc.

Embodiments of the present invention can also be used as an automated and dry method and system to prime seeds. Traditional seed priming methods such as (i) treatment with either water or chemicals, which are laborious and typically leads to non-uniform priming and fragile seeds with potentially reduced shelf life, and (ii) scarifying seeds against rough surface such as sandpaper, which comes with problems such as uneven scarification or thermal deterioration and physical damage due to excessive grinding. In example embodiments, lasers with a narrow range of wavelengths to create microstructures on seed surfaces is used to promote germination in seeds, which is rapid, dry and chemical-free process that produce shelf-stable primed seeds.

Authentication of Seeds by Creating Microstructure-Based Watermarks with Laser Irradiation According to Example Embodiments

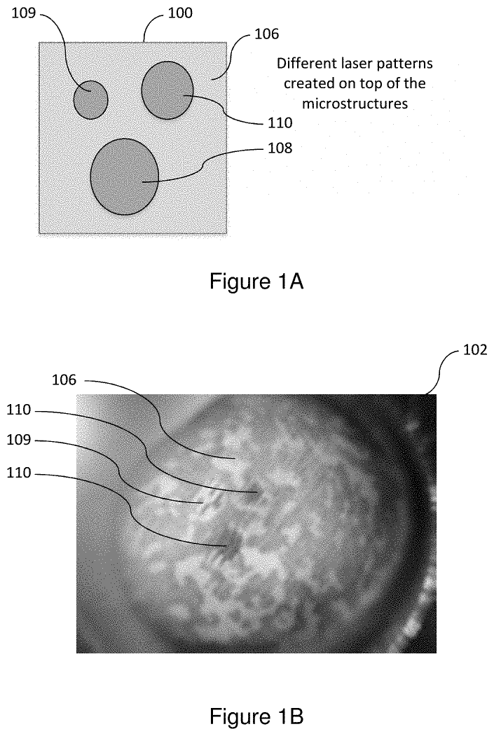

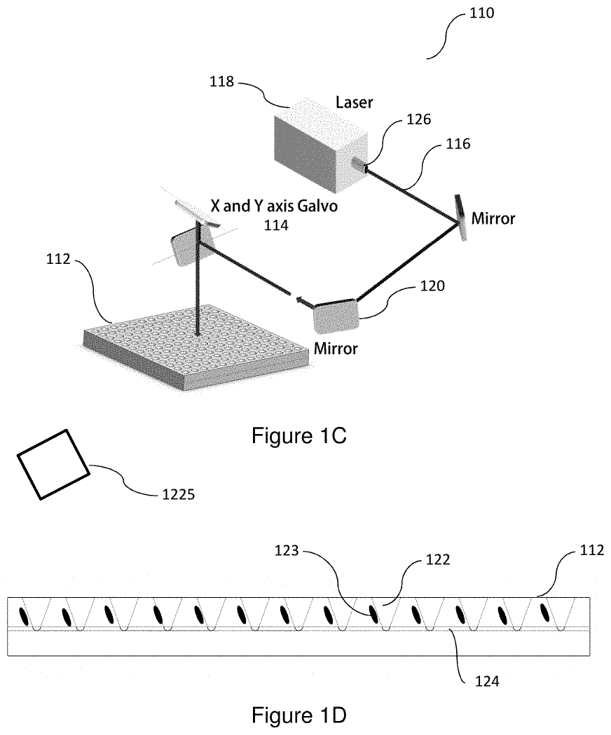

FIG. 1C shows a schematic drawing illustrating a laser system 110 for creating the microstructure-based watermark on the surfaces of the seeds according to an example embodiment. FIG. 1D shows a schematic drawing illustrating a cross section of the seed template 112 used in the laser system 110. The laser system 110 comprises a, laser galvo scanner 114 to steer the laser beam 116 from a laser source 118. A plurality of mirrors e.g. 120 for X and Y axis galvo scanning are shown by way of example, not limitation. The beam 116 is irradiated on the seed template 112 where the seeds are positioned. The seed template 112 and tapered holes e.g. 122 of the seed template 122 can come in different sizes, as required. The diameter of the holes e.g. 122 varies according to the seed size and shape. The holes e.g. 122 are tapered such that the seeds would be held in position, in addition to a vacuum suction being applied via channel network 124 to ensure that the seeds are held in position during laser ablation. The seed template 112 also preferably ensures a uniform focal length between the laser head 126 and the ablation point on the seed surface so that there will be uniformity in the creation of the microstructures.

As described in the background section, the existing process of authenticating seeds has mostly been done by conventional means of scanning barcodes or QR codes of seed packages, which is relatively easy to counterfeit. Embodiments of the present invention create an extremely difficult-to-duplicate mark with one or multiple layer(s) of microstructures, collectively termed ‘watermark’, directly on the surface of the seed coat (testa) of individual seeds that can be easily verified by the observer (aided or unaided eye, depending on the dimension of the microstructures created) for authentication purposes. As the laser scanning process is preferably done on seed testa that is directly above the endosperm, (and facing the laser) with the aim of preventing direct irradiation on the embryo, the well-controlled ablation of the testa can be observed compared to the non-treated side (facing away from the laser) as well as to completely untreated seeds. The microstructures created are targeted around the testa and for the second layer of patterns, around the hilum, according to example embodiments. Creation of microstructures is generally avoided close to the seed embryo according to example embodiments. Hence, the orientation of the seed before laser ablation occurs controlled to create microstructures at the targeted areas according to example embodiments. In one non-limiting example, multiple micro vibration motors e.g. 123 can be assembled at the sides of the tapered holes e.g. 122 to exact the orientation of the seed that is placed in the tapered hole e.g. 122, along with an image recognition system 125 to identify the orientation of the seed before laser ablation occurs. A pre-determined amount of voltage input to the vibration actuators is set according to the seed orientation, will be used according to example embodiments. Image recognition software can be used to recognize seeds that are in the incorrect orientation and subsequently correct the orientation mechanically, in this embodiment using the micro vibration motors e.g. 123.

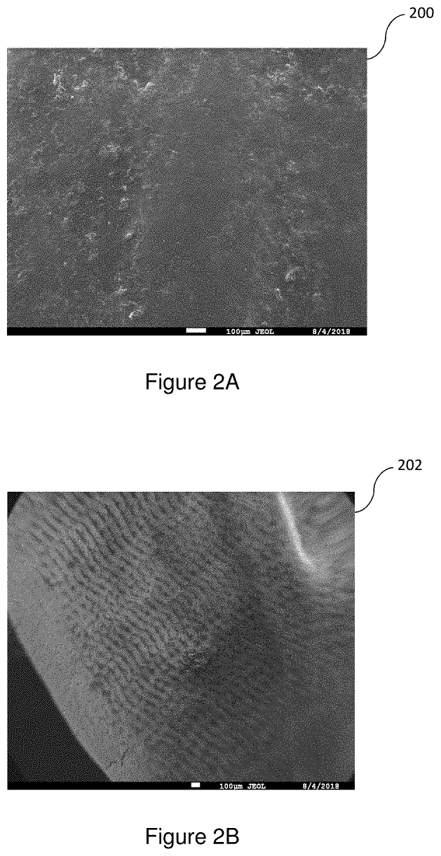

FIG. 1A shows a schematic drawing of a ‘watermark’ 100 according to a non-limiting example embodiment and FIG. 1B shows the actual image 102 of a maple pea seed (Pisum sativum var. arvense) with the ‘watermark’ 100 deposited on the seed testa. The microstructures were created with an ultrashort pulsed-laser (femtosecond laser with an average power of 2 W and 800-880 nm wavelength range in this case, noting that other pulse duration can be used in different embodiments, e.g. nano- and pico-second lasers) which can be seen with a microscope and/or analyzed by image processing algorithm. In this example embodiment, the microstructures were created by the laser in two successive rounds, with the first layer of microstructures (grooves in the micrometer range; demarcated by lighter shade 106 in FIG. 1A and discernable in FIG. 1B) being deposited first, followed by a second layer of microstructures (circles 108-110 in the millimeter range; demarcated by darker shade in FIG. 1A and discernable in FIG. 1B). FIGS. 2A and 2B show a more close-up comparison between a control seed (image 200, without laser irradiation) and seed with microstructures on the testa (image 202), respectively.

In example embodiments, for every batch of seed that has been marked, the details of the watermarks are recorded in a database. By continuously changing the creation parameters (including, but not limited to, laser power, duration and speed), embodiments of the present invention will create different watermarks that would be very difficult to replicate and probably deemed pointless to replicate, as every batch of seeds will have different results. Advantageously, the watermarks (i.e. one or more layers of microstructures) on the seed are also matched to information printed on the packaging in example embodiments. The information from the barcode packaging and seed markings with the laser must match to prove seed authenticity according to such embodiments.

The creation of the first layer of microstructures can depend on the seed type, structure and optical absorption capacities of the seed testa according to example embodiments. More layers of microstructures would increase the complexity of the watermark and hence increasing the difficulty in replicating the watermark.

The microstructures of the second layer can be targeted around the area where the radicle would emerge, according to example embodiments. The angle of radicle protrusion of a specific seed type is typically known, or can be determined, by the study of a set of similar seeds.

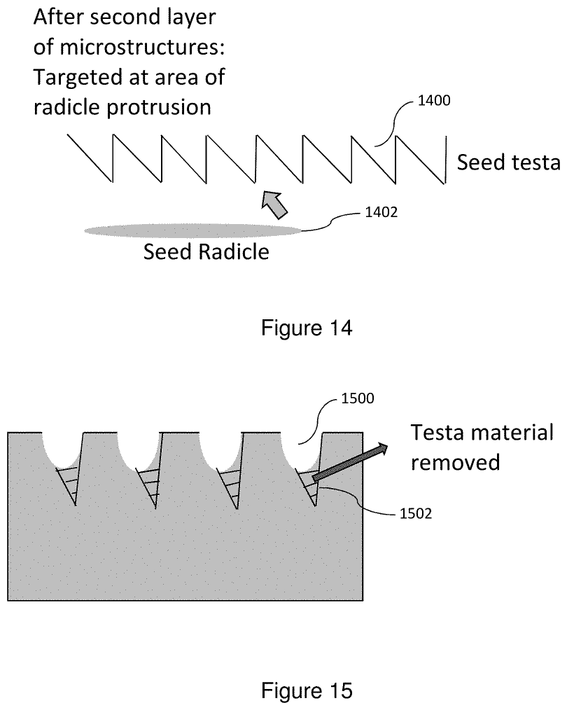

In one non-limiting example embodiment, the microstructures for the watermark are created as illustrated with reference to FIGS. 14 and 15, with a V-shaped or tapered groove e.g. 1400 that is tilted at an angle. The tilted axis of the groove e.g. 1400 is parallel to the projected radicle 1402 protrusion angle. This advantageously reduces the amount of mechanical resistance for the radicle 1402 to protrude based on the orientation of microstructures, and hence reduces the amount of energy for the testa rupture to occur. The method to create the microstructures in this targeted area at or near the radicle 1402 according to this example embodiment includes the use of different beam spot sizes. A first beam spot size is used for the first layer of microstructures in the form of grooves e.g. 1500 as shown in FIG. 15. The beam spot size is then reduced for the second layer of pattern within the grooves e.g. 1500 where a portion of testa material has been removed, and the scanning line is shifted by 20 to 80 microns from the initial scanning line for the first layer, so as to create the V-shaped or tapered groove e.g. 1400, indicated as silhouette 1502 in FIG. 15. Subsequent layers with reduced spot sizes/shifted scanning lines may be used in different embodiments to form the V-shaped or tapered groove. It is noted that the type of beam is not limited to a Gaussian beam, for example a Bessel beam can also be used to create more complex microstructures.

Embodiments of the present invention can also include the use of a mask for the laser marking process to create unique microstructure-based watermarks, typically in the millimeter range. In such embodiments, the laser beam scans over the mask so that the beam passes through a certain portion of the mask that has the desired first pattern to be laser marked. In the other portions of the mask the beam is absorbed by the mask material (for example, but not limited to, steel) and would not irradiate the surface of the seed. Preferred embodiments of the present invention comprise (1) using the combination of multiple layers of information (eg. first and second layers of microstructures of the watermark and (2) authentication is achieved by encoding information in the watermark by way of the microstructures of the first and/or second layers, which information is subsequently read/decoded by image recognition software. A mask-less method is used for the preferred embodiments for the creation of microstructures. The creation of microstructures are targeted at specific areas of the seed in preferred embodiments and is controllable such that the maximum depth of structures are within the perforated volume of the testa in preferred embodiments.

### Image Analysis for Authentication According to Example Embodiments

The images of the microstructure-based seed watermarks according to example embodiments captured by seed sellers and farmers will be sent to a database, in a preferred embodiment to a cloud based system. An image analysis algorithm according to example embodiments will then analyze these images. In one example embodiment, the algorithm first inspects via pattern identification and then zooms in on a particular area where the verification of the microstructures themselves takes place. By analyzing various parameters of the microstructures, including, but not limited to, the shape, size, spacing, depth and color (RGB colour and grey scale) of the microstructures, the image analysis algorithm according to example embodiments will be able to decode the information that was encoded in the watermark. This information can then be matched to the information that is printed on the seed packaging to validate the authenticity of the product according to example embodiments. On top of authentication, batch-specific information can also be encoded in the microstructure-based watermark with a system according to example embodiments, including, but not limited to, the batch number, date, country of origin, company name, etc. All this information will then be sent back to seed sellers and farmers for their reference. The entire process is expected to be rapid, preferably allowing “authentication-on-the-go”.

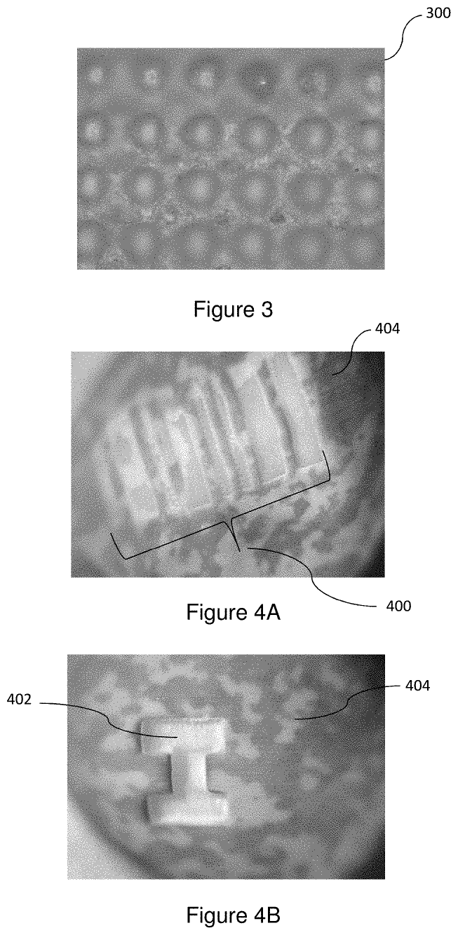

FIG. 3 shows an image 300 of a portion of another microstructure-based watermark created on Vigna radiata seed surface, according to an example embodiment.

FIGS. 4A and B show images of different second layer microstructures 400, 402, here in millimeter range, on top of the same first layer microstructures 404, here in micrometer range, together forming respective multi-layered microstructure-based watermarks according to example embodiments.

The creation of the microstructures according to example embodiments relies on the heat generated during laser irradiation. Excessive heat can have a negative impact on seed health and viability. Hence, according to a preferred embodiment, the use of a femtosecond laser, with its extremely short laser pulse duration, advantageously ablates away material before heat can be transferred to the delicate living interior of the seeds. Also, the cost of a femtosecond laser is a high barrier to entry to most counterfeiters. On the other hand, a cheaper alternative is the use of a nanosecond laser by counterfeiters but this has its own technical difficulties to replicate the formation of microstructures on the seed surface, especially if originally/genuinely intended to be formed by a femtosecond laser. For example, it is known that nanosecond lasers have inherent heat effects that would damage the precise creation of microstructures. This is especially during the laser ablation of the second layer of pattern where additional heat would damage the fine structures created in the first layer. It is also difficult for counterfeiters to replicate the formation of microstructures using other technologies like cold plasma etching that can leave a mark but yield inconsistent microstructures due to poor controllability allowed by alternate technologies.

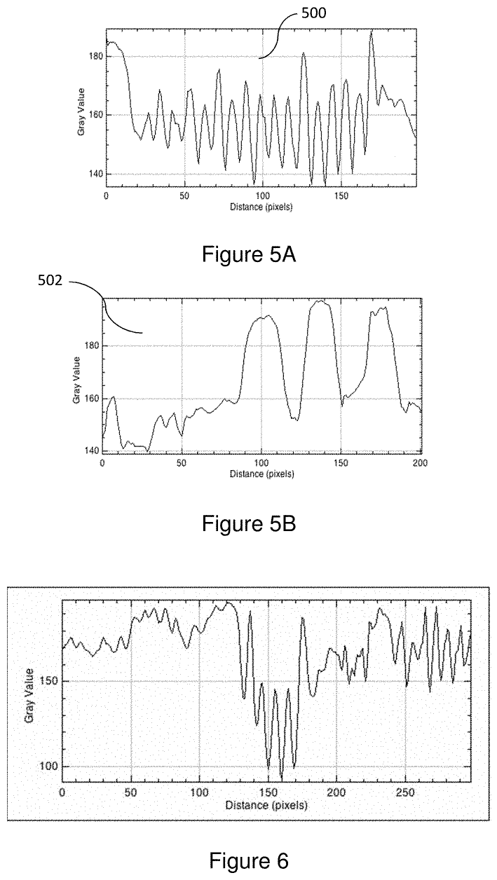

FIGS. 5A and B show surface morphology graphs after a post-image process illustrating that consistent microstructures 500 for a watermark according to an example embodiments can be observed in comparison to normal seed surface morphology 502, respectively.

FIG. 6 shows a surface morphology graph illustrating consistent first layer microstructures from 150-200 (distance, in pixels) and second layer microstructure on top of the first layer, from 100-150 (distance, in pixels).

Counterfeit seeds are a genuine problem faced by seed companies, which can reduce the sale of legitimate seeds, cause distrust between farmers and seed companies, and greatly compromise farmers' harvests and livelihoods because of the typically much poorer quality of counterfeit seeds. Creation of microstructures, in preferred embodiments with high-speed and ultrashort pulsed lasers, can provide farmers with a better assurance that the seeds that they are planting are legitimate. Seed companies will be able to ensure that the farmers can get what was promised which, in turn, promotes trust and efficiency in the agriculture industry.

Enhanced Germination Rate of Seeds by Creating Microstructures with Laser Irradiation According to Example Embodiments

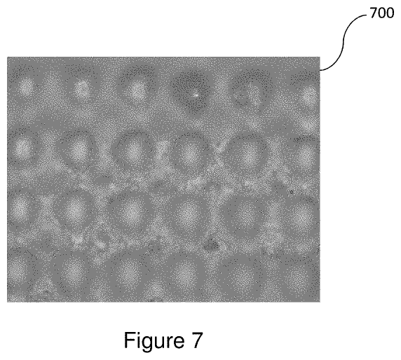

The creation of microstructures for enhanced germination according to example embodiments was done with laser irradiation or other methods as described above for the seed authentication according to example embodiments, and typically with a mesh writing pattern, which is an array of trenches/grooves. The heat effect by the laser would ablate the materials as the heat generation zone expands. The parameters controlled by the laser system (compare FIGS. 1C and D) will ultimately create different depths and width of the recess, according to example embodiments. FIG. 7 shows an image 700 of a portion of an example of microstructures on the seed coat of Vigna radiate to enhance germination, according to an example embodiment.

The varying types of microstructures were computed in the software to get the intended microstructure pattern. This was found to have implications on the effectiveness of germination rate according to different example embodiments. A Femtosecond laser was used with wavelength in the range of infrared, with flexibility in changing the extent of microstructures, in terms of material removed. Based on the parameters used, this may constitute the recipe for an individual type of seed, according to example embodiments.

It was found that the rate of seed germination can be controlled according to example embodiments, and varies based on the microstructures created, which can be controlled by tuning the laser parameters such as the pulse energy, scanning speed, pulse frequency and pulse repetition rate. The ultra-short pulsed femtosecond laser used according to a preferred embodiment is advantageously able to effectively remove material without generating significant heat that can affect the morphology, functionality and viability of the seed.

Seed trials were done with Vigna radiata, otherwise known as Mung Bean. Water uptake (or imbibition) is the trigger for germination to start and is required for the continuation of the germination process, hence enhancing the rate of imbibition is beneficial to achieve an increase in the germination rate. Vigna radiata seeds were chosen due to their fast germination speed of 1-2 days.

The method according to example embodiments can speed up the growing process from germination to the final product of a bean sprout, which in turn can potentially reduce food scarcity issues. Many different types of seeds can be treated according to various example embodiments, not limited to the size and material of the seed coat. Embodiments of the present invention remove material as well as create specific microstructures on the seed coat (testa), which is composed of desiccated material, formed by natural drying of the seed after pollination.

As will be appreciated by a person skilled in the art, there are many ways to water seeds but two example methods were used for the seed trials according to example embodiment. The first method was to place them in a medium that can readily retain water moisture. The second method is one whereby the seeds are soaked in water for 8 hours. The results of the seed trials are described below and shown in the accompanying Figures. A total of nine seeds for each laser irradiation parameter set were used in a particular seed trial to test the efficacy of the technology according to example embodiments, with a total of 25 seed trials. The results described below are a selection of the seed trials done and it is noted that improvement in the germination rate was seen for the various seed trials done.

The results were measured according to germination ratings. Vigna radiata seeds grow through a growth stage depicted below and a corresponding rating (left column) was given for every different stage the seed has grown into.

| | |
|---|---|
| 0 | Show signs of bloatedness |
| 1 | Minimal protrusion of radical |
| 2 | Show initial signs of testa uncovering with minimal protrusion of |
| | radical |
| 3 | Most of the testa has uncovered (>0.5 of circumference of contour) |
| 4 | Slight protrusion of radical with testa uncovered (>0.5 of |
| | circumference of contour) |
| 5 | Radical protrusion by length of 1 mm-5 mm |
| 6 | Radical protrusion by length of more than 5 mm |

The results described below show trials where pulse energy was increased incrementally. The results of two different methods of water uptake are also shown.

### Legend

(−) would mean seeds without laser irradiation
(A1 to A9) are seeds that have been laser irradiated with different pulse energy parameters Pulse energies for A1 to A9 are: 0.2 mJ, 0.4 mJ, 0.6 mJ, 0.8 mJ, 1 mJ, 1.2 mJ, 1.4 mJ, 1.6 mJ, 1.8 mJ. Femtosecond laser (240 fs) wavelength ˜800 nm with average power of 2 W and pulse repetition of 1 kHz. It is noted that the table that shows A1f, A3f, A5f and A7f are a repeated trial with the same parameters as A1, A3, A5 and A7 respectively.

### First Watering Method

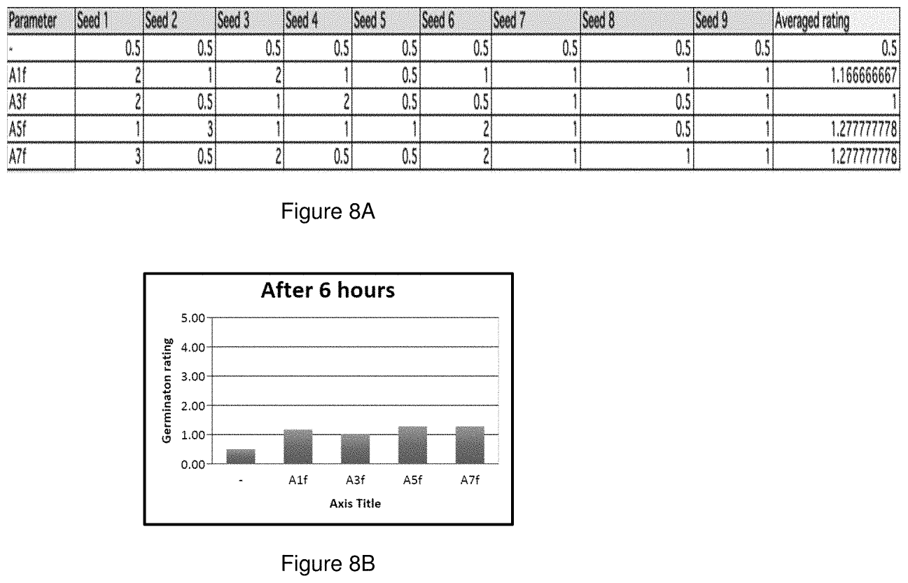

FIGS. 8A and B show the germination rating after 6 hours (placed in a medium that can readily retain water moisture, i.e. without soaking) in table form and in graph form, respectively, according to example embodiments.

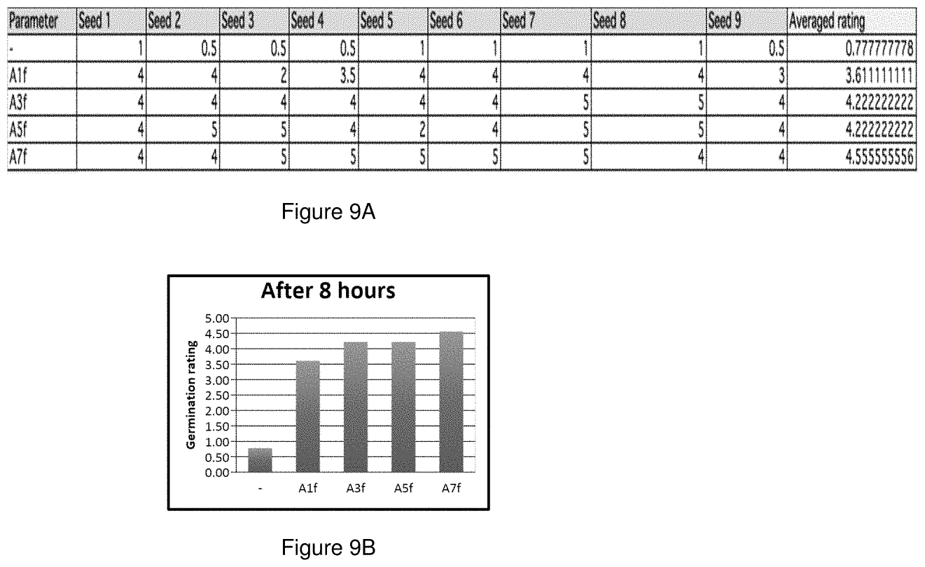

FIGS. 9A and B show results germination rating after 8 hours (placed in a medium that can readily retain water moisture, i.e. without soaking) in table form and in graph form, respectively, according to example embodiments.

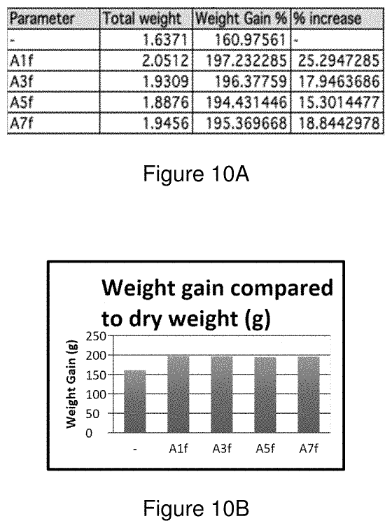

FIGS. 10A and B show weight gain compared to the dry weight after 20 hours in table form and in graph form, respectively, according to example embodiments.

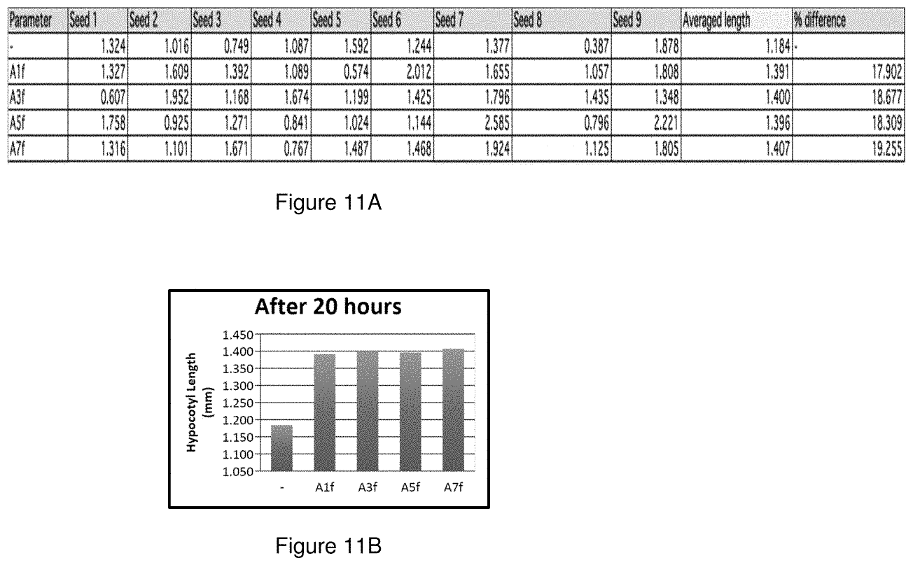

FIGS. 11A and B show length after 20 hours (placed in a medium that can readily retain water moisture, without soaking) Length of hypocotyl (in mm) in table form and in graph form, respectively, according to example embodiments.

### Second Watering Method

After 8 hours of submerging/soaking the seeds, they were rinsed and subsequent rinsing after every 4 hours.

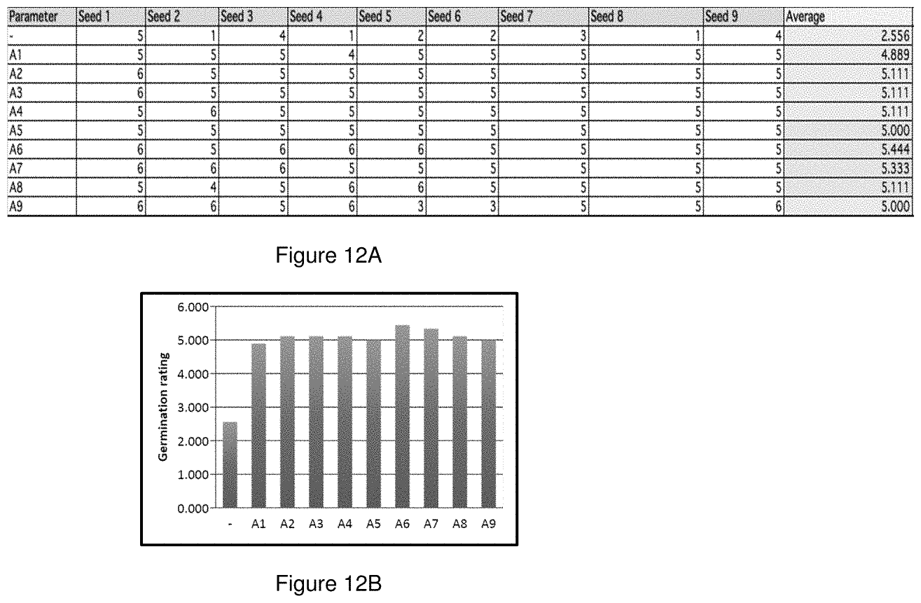

FIGS. 12A and B show results of germination rating after 8 hours of submerged seeds in table form and in graph form, respectively, according to example embodiments.

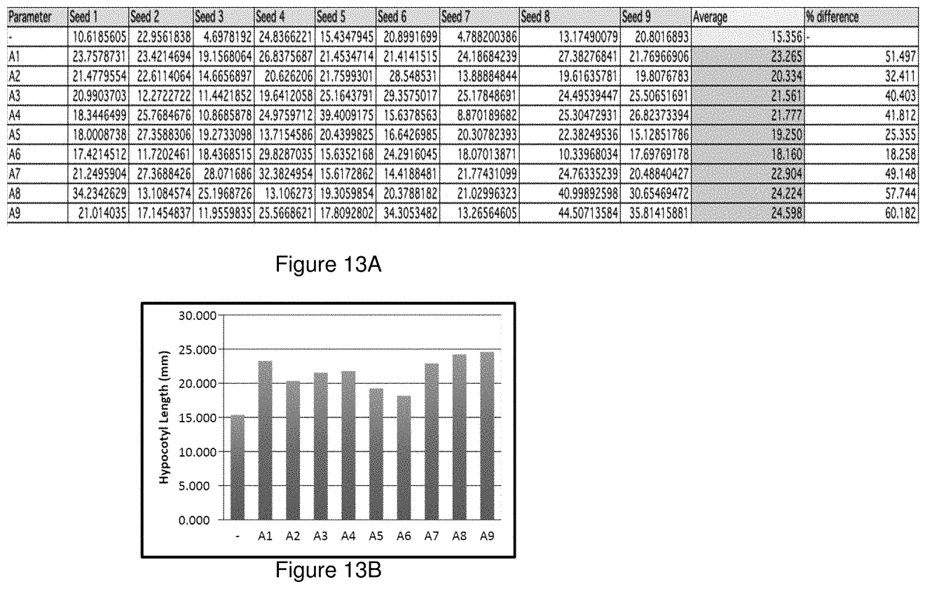

FIGS. 13A and B show lengths of hypocotyl (in mm) after 20 hours with soaking in table form and in graph form, respectively, according to example embodiments.

The results do evidently show an increase in germination rate and water uptake based on hypocotyl radicle root length measured and the dry to wet ratio measured, respectively

Therefore, the increase in germination is believed to be mainly due to the increase in water absorption based on the mechanisms discussed below. The microstructures created are the basis of the increase in water uptake of the seed according to example embodiments.

Microstructures are created to provide an increase in surface area of the seed testa that are in contact with water. Varying the laser parameters used can modify the degree of increase of surface area in a laser-irradiated seed with microstructures according to example embodiments, compared to a normal seed. This can be done, for example, by increasing laser power and/or increasing the laser repetition rate. Water uptake increases with an increased surface area ratio.

The water uptake pathway can occur not only via the original inward path (via micropyle) but water can also permeate through the side-walls of the microstructure. An obvious indication of this can be seen with the rapid expansion of the seed testa upon imbibition as evident in the results.

A water pressure gradient is preferably formed by the microstructures according to example embodiments, thus increasing the permeability of the seed coat to water. A higher water pressure is expected at the bottom of the microstructures according to example embodiments, which advantageously creates an inward water pressure towards the center of the seed. The microstructures created according to preferred embodiments have a tapered result to form a V-shaped groove (compare FIGS. 14 and 15 and corresponding description above) which creates a sharp point where minimal energy is required to break the bottom of the groove as the seed expands, in addition to higher fluid pressure in the groove at the bottom. In addition, the sidewalls of the microstructures according to example embodiments can create a turbulent cyclic water flow in the trench. The force of the fluid advantageously enhances the inward pressure and hence the water uptake. As described above with reference to FIGS. 14 and 15, according the beam spot size, the line width (distance between two scanning laser spots) used range from an addition of 20 micrometer to 80 micrometer according to example embodiments.

The microstructures according to example embodiments also affect the turgor pressure of the seed as water is imbibed more readily. The turgor pressure in the seed not only creates an osmotic potential but also improves the ease of testa removal as the seed germinates. The seed expands during imbibition (Stage I) and reactions with respect to water and the storage reserves of the seed (mainly the cotyledons or endosperm) (Stage II) and hence the testa begins to rupture and break open as the seed germinates.

On the other hand, the microstructures according to example embodiments preferably enable that less outward expansion of the seed is needed to fully remove the testa, enhancing the process of expansion, using, for example, the microstructures that have a tapered result to form a V-shaped groove (compare FIGS. 14 and 15 and corresponding description above). It is believed that the ‘extra’ energy conserved by this process can be used for other important purposes during seed development.

In addition, the initial rupture (first tear of the seed testa) can occur easily with lesser force at the trenches/grooves according to example embodiments. During imbibition, the seed will absorb water and expand in size, which generates an imbibitional pressure (outwards). For a seed that is not irradiated by a laser, the entire seed testa will experience similar pressure since the thickness is uniform. However, for a laser irradiated seed, the thickness of the testa at trenches/grooves is reduced than the ‘un-trenched’ areas of the testa, which creates a weak point where the stress is higher, thereby causing fracture

In the soil, seed water uptake is highly dependent on the soil matrix and how the microstructures according to example embodiments on the surface of the seed trap water. As shown in the results of two different methods of watering the seeds described above according to example embodiments, water availability plays an important part in the rate of growth. However, the microstructures formed according to example embodiments preferably give an added advantage of absorbing water.

The microstructures created according to example embodiments preferably induce a more uniform absorbance or transmittance of light by the seed. In particular, red and far-red wavelengths have an influence on germination. The precision and accuracy of the laser irradiated method creates a more uniform testa layer via the inclusion of microstructures, as compared to a normal seed testa. The uniformity of absorbance or reflection of light influenced by the microstructures created would influence the uniformity of this effect. In addition, the effects of using a red laser to irradiate the germinating seed, in particularly in the red spectrum with wavelength ranging between 600 nm to 750 nm, was also shown to enhance germination of various type of light-sensitive seeds, including Raphanus dativus [Representation of He—Ne laser irradiation effect on radish seeds with selected germination indices, Int. Agrophysics, 2008, 22, 151-157, Apr. 8, 2008] (radish) and Medicago sativaalfalfa (alfalfa) [Laser stimulation effect of seeds on quality of alfalfa, Int. Agrophysics, 2010, 24, 15-19, Apr. 2, 2009]. This phenomenon is thought to work via phytochromes, which are a class of photoreceptor in plants that are sensitive to the red and far-red region of the visible spectrum.

It is noted that embodiments of the present invention are not limited to the type of medium (medium here refers to the substrate used to hold the moisture or nutrient needed for plant germination and growth eg soil, rockwool, coco fiber and etc.) used as the mechanism is directly influenced by the microstructures on the seed itself, according to example embodiments. Advantageously, embodiments of the present invention can provide more uniform growth, increased germination percentage or increased rate of germination without the challenges in traditional priming methods which typically require wetting the seeds

Compared to conventional methods of priming (i.e; wetting and drying of the seeds), embodiments of the present invention can have one or more of the following significant advantages.

Firstly, the duration of the priming process can be much shorter than conventional ones and the laser set up according to an example embodiment can treat more than a thousand seeds per minute, depending on seed size. Secondly, embodiments of the present invention can provide a chemical free process that eliminates the complexity and reduces the labor intensiveness of the priming process. As described, embodiment of the present invention can provide an entirely dry process and can possibly increase the cleanness and safety of vegetable harvesting, by reducing the presence of chemicals. Thirdly, as it can be an entirely a dry process, embodiments of the present invention can reduce the complexity of the seed priming process as special priming expertise is not needed. Fourthly, longer shelf life is expected using example embodiments of the present invention compared to conventional methods using chemicals or matrix priming. The difficulty in controlling the timing to dry the seeds upon initial imbibition as in traditional “wet” priming processes can be avoided. Fifthly, unlike chemical and physical scarification methods, which can be difficult to control, laser irradiation according to some example embodiments, can precisely and repeatedly control the amount of material removed from, and the microstructures formed on, the seed coat.

In one embodiment, a method of seed authentication is provided comprising marking the testa of a seed with a watermark comprising an area in which the testa is at least partially removed by forming microstructures in the testa.

The watermark may comprise two or more layers of microstructures formed on top of each other in the area of the watermark.

Respective layers may have different parameters for the microstructures of the respective layers.

The watermark may be verifiable by naked-eye and/or image processing.

The microstructures may be verifiable by image processing to derive authentication information based on an analysis of details of the microstructures.

The method may further comprise providing information on a package for the seed, wherein the information on the package is matchable to the watermark.

Forming the microstructures may comprise laser marking.

The laser marking may comprise using an ultrashort pulsed-laser.

The ultrashort pulsed laser may comprise a femto-, nano- or pico-second laser.

Forming the microstructures may be controlled by controlling one or more of a group consisting of laser power, duration, laser repetition rate, and speed.

The microstructures may be characterized by depths and/or widths of laser markings.

The laser marking may comprises using a mask.

In one embodiment, a method for improving seed germination is provided, the method comprising marking an area of the testa of a seed by forming microstructures in the area to enhance imbibition.

The area may be the area where the radicle would emerge.

The microstructures may be configured to one or more of a group consisting of:

comprise a tilted wall at an angle parallel to a projected radicle protrusion angle for reducing the amount of mechanical resistance for the radicle to protrude,
form a water pressure gradient during imbibition for increasing the permeability of the testa,
comprise a sharp point where minimal energy is required to break a bottom of the groove as the seed expands,
create a turbulent cyclic water flow in the trench for enhancing an inward water pressure and hence the water uptake,
affect the turgor pressure for creating an osmotic potential and improving ease of testa removal as the seed germinates, and
enhance absorbance or transmittance of light by the seed, in particular for red and far-red wavelengths having an influence on germination.

In one embodiment, a device for marking the testa of a seed with a watermark is provided, comprising an area in which the testa is at least partially removed by forming microstructures in the testa, for seed authentication.

The device may be configured such that the watermark comprises two or more layers of microstructures formed on top of each other in the area of the watermark.

The device may be configured such that respective layers have different parameters for the microstructures of the respective layers.

The device may be configured such that the watermark is verifiable by naked-eye and/or image processing.

The device may be configured such that the microstructures are verifiable by image processing to derive authentication information based on an analysis of details of the microstructures.

The device may be configured for forming the microstructures by laser marking.

The laser marking may comprise using an ultrashort pulsed-laser.

The ultrashort pulsed laser may comprises a femto-, nano- or pico-second laser.

The device may be configured such that forming the microstructures is controlled by controlling one or more of a group consisting of laser power, duration, laser repetition rate, and speed.

The microstructures may be characterized by depths and/or widths of laser markings.

The laser marking may comprise using a mask.

In one embodiment, a device for marking an area of the testa of a seed by forming microstructures in the area to enhance imbibition is provided, for improving seed germination.

The area may be the area where the radicle would emerge.

The microstructures may be configured to one or more of a group consisting of:

comprise a tilted wall at an angle parallel to a projected radicle protrusion angle for reducing the amount of mechanical resistance for the radicle to protrude,
form a water pressure gradient during imbibition for increasing the permeability of the testa,
comprise a sharp point where minimal energy is required to break a bottom of the groove as the seed expands,
create a turbulent cyclic water flow in the trench for enhancing an inward water pressure and hence the water uptake,
affect the turgor pressure for creating an osmotic potential and improving ease of testa removal as the seed germinates, and
enhance absorbance or transmittance of light by the seed, in particular for red and far-red wavelengths having an influence on germination.

Embodiments of the present invention, on the one hand, provide for authentication of seeds on a seed-level and, alternatively or additionally provide a form of priming, which increases the rate of germination. Embodiments of the present invention for seed authentication can have one or more of the following features and associated benefits/advantages:

| Feature | Benefit/Advantage |
|---|---|
| Laser mark | Easily verifiable and difficult to replicate |
| Microstructures created | When observed under a microscope, can |
| | observe well defined and consistent structures; |
| | difficult to replicate with other technologies |
| Continually changing | Difficulty in replicating |
| parameters | |

Embodiments of the present invention can have application in agriculture, horticulture, laser applications, seed research, by way of example, not limitation.

Aspects of the systems and methods described herein, such as the implementation and/or control of the system for creating the microstructures, such as a femto laser system, and the authentication processing for seed authentication, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course, the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A method of seed authentication comprising marking a testa of a seed with a watermark comprising an area in which the testa is at least partially removed by forming microstructures in the testa.

2. The method of claim 1, wherein the watermark comprises two or more layers of microstructures formed on top of each other in the area of the watermark, and optionally wherein respective layers have different parameters for the microstructures of the respective layers.

3. (canceled)

4. The method of claim 1, wherein the watermark is verifiable by naked-eye and/or image processing.

5. The method of claim 1, wherein the microstructures are verifiable by image processing to derive authentication information based on an analysis of details of the microstructures.

6. The method of claim 1, further comprising providing information on a package for the seed, wherein the information on the package is matchable to the watermark.

7. The method of claim 1, wherein forming the microstructures comprises laser marking, and optionally wherein the laser marking comprises using an ultrashort pulsed-laser, and optionally wherein the ultrashort pulsed laser comprises a femto-, nano- or pico-second laser.

8. (canceled)

9. (canceled)

10. The method of claim 7, wherein forming the microstructures is controlled by controlling one or more of a group consisting of laser power, duration, laser repetition rate, and speed, and optionally wherein the microstructures are characterized by depths and/or widths of laser markings.

11. (canceled)

12. The method of claim 7, wherein the laser marking comprises using a mask.

13. A method for improving seed germination, the method comprising marking an area of a testa of a seed by forming microstructures in the area to enhance imbibition.

14. The method of claim 13, wherein the area is the area where the radicle would emerge, and optionally wherein the microstructures are configured to one or more of a group consisting of:
comprise a tilted wall at an angle parallel to a projected radicle protrusion angle for reducing the amount of mechanical resistance for the radicle to protrude,
form a water pressure gradient during imbibition for increasing the permeability of the testa,
comprise a sharp point where minimal energy is required to break a bottom of the groove as the seed expands,
create a turbulent cyclic water flow in the trench for enhancing an inward water pressure and hence the water uptake,
affect the turgor pressure for creating an osmotic potential and improving ease of testa removal as the seed germinates, and
enhance absorbance or transmittance of light by the seed, in particular for red and far-red wavelengths having an influence on germination.

15. The method of claim 14, wherein the microstructures are configured to one or more of a group consisting of:
comprise a tilted wall at an angle parallel to a projected radicle protrusion angle for reducing the amount of mechanical resistance for the radicle to protrude,
form a water pressure gradient during imbibition for increasing the permeability of the testa,
comprise a sharp point where minimal energy is required to break a bottom of the groove as the seed expands,
create a turbulent cyclic water flow in the trench for enhancing an inward water pressure and hence the water uptake,
affect the turgor pressure for creating an osmotic potential and improving ease of testa removal as the seed germinates, and
enhance absorbance or transmittance of light by the seed, in particular for red and far-red wavelengths having an influence on germination.

16. A device for marking the testa of a seed with a watermark or for marking an area of the testa of a seed by forming microstructures in the area to enhance imbibition, for improving seed germination, the device comprising an area in which the testa is at least partially removed by forming microstructures in the testa, for seed authentication.

17. The device of claim 16, wherein the device is configured such that the watermark comprises two or more layers of microstructures formed on top of each other in the area of the watermark, and optionally wherein the device is configured such that respective layers have different parameters for the microstructures of the respective layers.

18. (canceled)

19. The device of claim 16, wherein the device is configured such that the watermark is verifiable by naked-eye and/or image processing.

20. The device of claim 16, wherein the device is configured such that the microstructures are verifiable by image processing to derive authentication information based on an analysis of details of the microstructures.

21. The device of claim 16, wherein the device is configured for forming the microstructures by laser marking, and optionally wherein the laser marking comprises using an ultrashort pulsed-laser, and optionally wherein the ultrashort pulsed laser comprises a femto-, nano- or pico-second laser.

22. (canceled)

23. (canceled)

24. The device of claim 21, wherein the device is configured such that forming the microstructures is controlled by controlling one or more of a group consisting of laser power, duration, laser repetition rate, and speed, and optionally wherein the microstructures are characterized by depths and/or widths of laser markings.

25. (canceled)

26. The device of claim 21, wherein the laser marking comprises using a mask.

27. (canceled)

28. The device of claim 16, wherein the area is the area where the radicle would emerge.

29. The device of claim 28, wherein the microstructures are configured to one or more of a group consisting of:
comprise a tilted wall at an angle parallel to a projected radicle protrusion angle for reducing the amount of mechanical resistance for the radicle to protrude,
form a water pressure gradient during imbibition for increasing the permeability of the testa,
comprise a sharp point where minimal energy is required to break a bottom of the groove as the seed expands,
create a turbulent cyclic water flow in the trench for enhancing an inward water pressure and hence the water uptake,
affect the turgor pressure for creating an osmotic potential and improving ease of testa removal as the seed germinates, and
enhance absorbance or transmittance of light by the seed, in particular for red and far-red wavelengths having an influence on germination.
